(19) United States
(12) Patent Application Publication
(10) Pub. No.: US 2010/0053414 A1
(43) Pub. Date: Mar. 4, 2010

(54) COMPOUND EYE CAMERA MODULE

(76) Inventors: Satoshi Tamaki, Kanagawa (JP); Norihiro Imamura, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/598,096

(22) PCT Filed: Jan. 9, 2009
(86) PCT No.: PCT/JP2009/000067

§ 371 Date: Oct. 29, 2009

(30) Foreign Application Priority Data
Jan. 11, 2008 (JP) 2008-004002

(51) Int. Cl. H04N 5/225; B32B 37/00

(52) U.S. Cl. 348/340; 156/60; 348/E05.024

(57) ABSTRACT

A compound eye camera module according to the present invention includes a lens array including a plurality of lenses located on the same plane; an imaging section including a plurality of imaging areas on which a plurality of images of a subject formed by the plurality of lenses are projected in a one-to-one relationship, the imaging section converting each of the plurality of projected images into an electric signal; and an optical aperture section including a plurality of optical apertures corresponding to the plurality of lenses in a one-to-one relationship and located oppositely to the imaging section with respect to the lens array. A difference between a linear expansion coefficient of a material used to form the lens array and a linear expansion coefficient of a material used to form the optical aperture section has an absolute value of 0.7×10⁻⁵/° C. or less.

### TECHNICAL FIELD

The present invention relates to a compound eye camera module for taking an image by a plurality of imaging optical lenses.

### BACKGROUND ART

An imaging device such as a digital video camera or a digital camera forms an image of a subject on an imaging element such as a CCD, a CMOS or the like via a lens to convert the image of the subject into two-dimensional image information. Recently, cameras for obtaining a plurality of two-dimensional images of a subject using a plurality of lenses and measuring a distance to the subject based on the obtained image information have been proposed.

Patent Document 1 discloses an example of such a compound eye camera module for measuring a distance to the subject. FIG. 10 is an exploded isometric view of a compound eye camera module disclosed in Patent Document 1. The compound eye camera module includes an optical aperture member 111, a lens array 112, a light shielding block 113, an optical filter array 114, and an imaging element 116 which are located in this order from the side of the subject. The lens array 112 includes a plurality of lenses 112a. The optical aperture member 111 has optical apertures at positions respectively matching the optical axes of the lenses of the lens array 112. The optical filter array 114 includes a plurality of optical filters having different spectral characteristics respectively for areas corresponding to the lenses of the lens array 112, and covers a light receiving surface of the imaging element 116. The light shielding block 113 includes light shielding walls 113a at positions matching the borders between adjacent lenses of the lens array 112, namely, the borders between adjacent optical filters of the optical filter array 114. The imaging element 116 is mounted on a semiconductor substrate 115. On the semiconductor substrate 115, a driving circuit 117 and a signal processing circuit 118 are mounted.

An image having parallax is obtained by a camera module having such a structure. Using the technique called “block matching”, a block which is most similar to an arbitrary block in a basic image 7-1 is searched for in a reference image 7-2 to calculate a parallax amount. Based on the parallax amount, a distance to the subject is calculated.

Patent Document 1: Japanese Laid-Open Patent Publication No. 2003-143459

### DISCLOSURE OF THE INVENTION

### Problems to be Solved by the Invention

However, with the compound eye camera module disclosed in Patent Document 1, when the environmental temperature changes, the focal distance of each lens of the lens array or base line length, which is the distance between optical axes of the lenses, changes. As a result, the accuracy of the distance measurement is deteriorated. Patent Document 1 does not describe anything on how to solve this problem.

The present invention made to solve such a problem of the conventional art has an object of providing a compact and low-cost compound eye camera module which guarantees accurate distance measurement even when the environmental temperature changes.

### Means for Solving the Problems

A compound eye camera module according to the present invention includes a lens array including a plurality of lenses located on the same plane; an imaging section including a plurality of imaging areas on which a plurality of images of a subject formed by the plurality of lenses are projected in a one-to-one relationship, the imaging section converting each of the plurality of projected images into an electric signal; and an optical aperture section including a plurality of optical apertures corresponding to the plurality of lenses in a one-to-one relationship and located oppositely to the imaging section with respect to the lens array. A difference between a linear expansion coefficient of a material used to form the lens array and a linear expansion coefficient of a material used to form the optical aperture section has an absolute value of 0.7×10⁻⁵/° C. or less.

In a preferable embodiment, a difference between a linear expansion coefficient of a material used to form the lens array and a linear expansion coefficient of a material used to form the optical aperture section has an absolute value of 0.35×10⁻⁵/° C. or less.

In a preferable embodiment, a difference between a linear expansion coefficient of a material used to form the lens array and a linear expansion coefficient of a material used to form the optical aperture section has an absolute value of 0.2×10⁻⁵/° C. or less.

In a preferable embodiment, the optical aperture section includes hoods for restricting an angle of view.

In a preferable embodiment, the optical aperture section and the lens array are positioned with respect to each other in a state of contacting each other, such that the center of each of the optical apertures of the optical aperture section matches an optical axis of the corresponding lens of the lens array.

In a preferable embodiment, the optical aperture section has a structure in which positions of the plurality of optical apertures are independently adjustable.

In a preferable embodiment, the compound eye camera module further includes a lens barrel for supporting the optical aperture section and the imaging section. The lens array and the optical aperture section are fixed to each other by a first adhesive located symmetrically with respect to the center of the lens array in a plane vertical to the optical axes of the lenses. The lens barrel and the optical aperture section are fixed to each other by a second adhesive located symmetrically with respect to the center of the lens array in the plane vertical to the optical axes of the lenses.

A method for producing a compound eye camera module according to the present invention is for producing a compound eye camera module including a lens array including a plurality of lenses located on the same plane; an imaging section including a plurality of imaging areas on which a plurality of images of a subject formed by the plurality of lenses are projected in a one-to-one relationship, the imaging section converting each of the plurality of projected images into an electric signal; and an optical aperture section including a plurality of optical apertures corresponding to the plurality of lenses in a one-to-one relationship and located oppositely to the imaging section with respect to the lens array; wherein a difference between a linear expansion coefficient of a material used to form the lens array and a linear expansion coefficient of a material used to form the optical aperture section has an absolute value of 0.7×10⁻⁵/° C. or less. The method includes the step of binding together the optical aperture section and the lens module by a first adhesive in the state where a plane of the optical aperture section which is parallel to the optical axes of the lenses is in contact with a plane of the lens module which is parallel to the optical axes of the lenses such that the center of each optical aperture of the optical aperture section is located on the optical axis of the corresponding lens.

In a preferable embodiment, the lens array and the optical aperture section are fixed to each other by locating the first adhesive symmetrically with respect to the center of the lens array in a plane vertical to the optical axes of the lenses.

### EFFECTS OF THE INVENTION

According to the present invention, the difference in the linear expansion coefficient between the material of the lens array and the material of the optical aperture section is set to 0.7×10⁻⁵/° C. or less. Owing to this, the decentration amount between the optical axes of the lenses and the centers of the optical apertures is suppressed from changing in accordance with the environmental temperature, although such a change is difficult to be corrected merely by considering the expansion amount or shrinkage amount of the materials used to form the compound eye camera module in accordance with the environmental temperature. Since the decentration amount is suppressed from changing, the change of the parallax amount can also be suppressed. Accordingly, high distance measurement accuracy can be maintained. The distance measurement accuracy can be improved even in a compact compound eye camera module having a short base line length.

### BRIEF DESCRIPTION OF THE DRAWINGS

FIG. 1 is a cross-sectional view showing an embodiment of a compound eye camera module according to the present invention, taken along a plane parallel to a side surface thereof.

FIG. 2 is a cross-sectional view of a unit formed of an optical aperture section and a lens array, taken along a plane parallel to a side surface thereof, of the compound eye camera module shown in FIG. 1.

FIG. 3 is a front view of the unit shown in FIG. 2.

FIG. 4 is an exploded isometric view of the unit shown in FIG. 2.

FIG. 5 explains the principle of calculating the distance in the compound eye camera module shown in FIG. 1.

FIG. 6 is a graph showing the relationship between the image height and the change ratio of the parallax in the case where the center of the optical aperture is decentered with respect to the optical axis of the lens.

FIG. 7 is another graph showing the relationship between the image height and the change ratio of the parallax in the case where the center of the optical aperture is decentered with respect to the optical axis of the lens.

FIG. 8(a) shows the position of an adhesive for binding the lens array and the optical aperture module; FIG. 8(b) shows the position of an adhesive for binding the optical aperture section and a lens barrel; and FIG. 8(c) is a cross-sectional view showing the positions of the adhesives shown in FIG. 8(a) and FIG. 8(b).

FIG. 9 is a cross-sectional view showing another embodiment of the optical aperture section used for the compound eye camera module according to the present invention, which is taken along a plane parallel to a side surface thereof.

FIG. 10 is an exploded isometric view of a conventional compound eye camera module.

### DESCRIPTION OF THE REFERENCE NUMERALS

1 Optical aperture section
2a, 2b Optical aperture
3a, 3b Hood
4 Lens array
4a, 4b Lens
5 Lens barrel
6 Imaging section
6a, 6b Imaging area
7 Optical filter
8 Light shielding wall

### BEST MODE FOR CARRYING OUT THE INVENTION

Hereinafter, one embodiment of a compound eye camera module according to the present invention will be described with reference to the drawings.

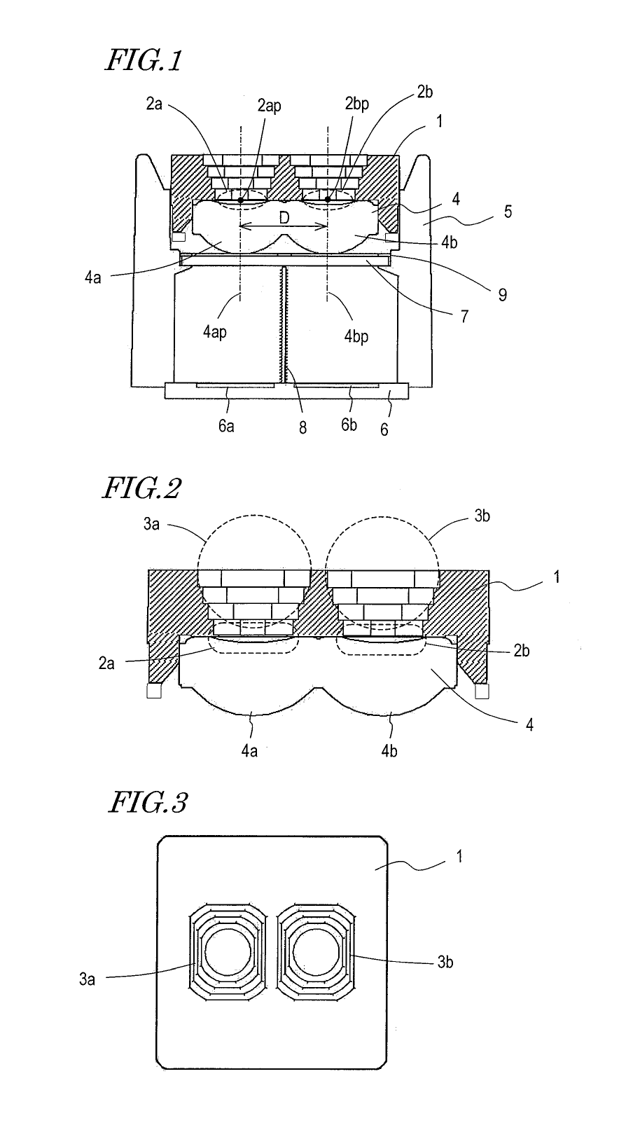

FIG. 1 is a cross-sectional view of a compound eye camera module in this embodiment taken along a plane parallel to a side surface thereof, which shows main components thereof. The compound eye camera module includes an optical aperture section 1, a lens array 4, a lens barrel 5, and an imaging section 6.

The lens array 4 includes two lenses 4a and 4b located on the same plane, and the lenses 4a and 4b are integrally formed of resin molding or the like. The optical aperture section 1 is located on the side of a subject with respect to the lens array 4. The optical aperture section 1 includes optical apertures 2a and 2b corresponding to the lenses 4a and 4b in a one-to-one relationship. The optical apertures 2a and 2b respectively have openings for restricting the amount of light incident on the lenses 4a and 4b. The lens array 4 and the optical aperture section 1 are positioned such that centers 2ap and 2bp of the optical apertures 2a and 2b respectively match the optical axes 4ap and 4bp of the lenses 4a and 4b. The lens array 4 and the optical aperture section 1 are bound together to form a unit. The expression that “the centers 2ap and 2bp respectively match optical axes 4ap and 4bp” means that the decentration amount of the centers 2ap and 2bp with respect to the optical axes 4ap and 4bp is generally 5 μm or less, in addition to being exactly 0 μm.

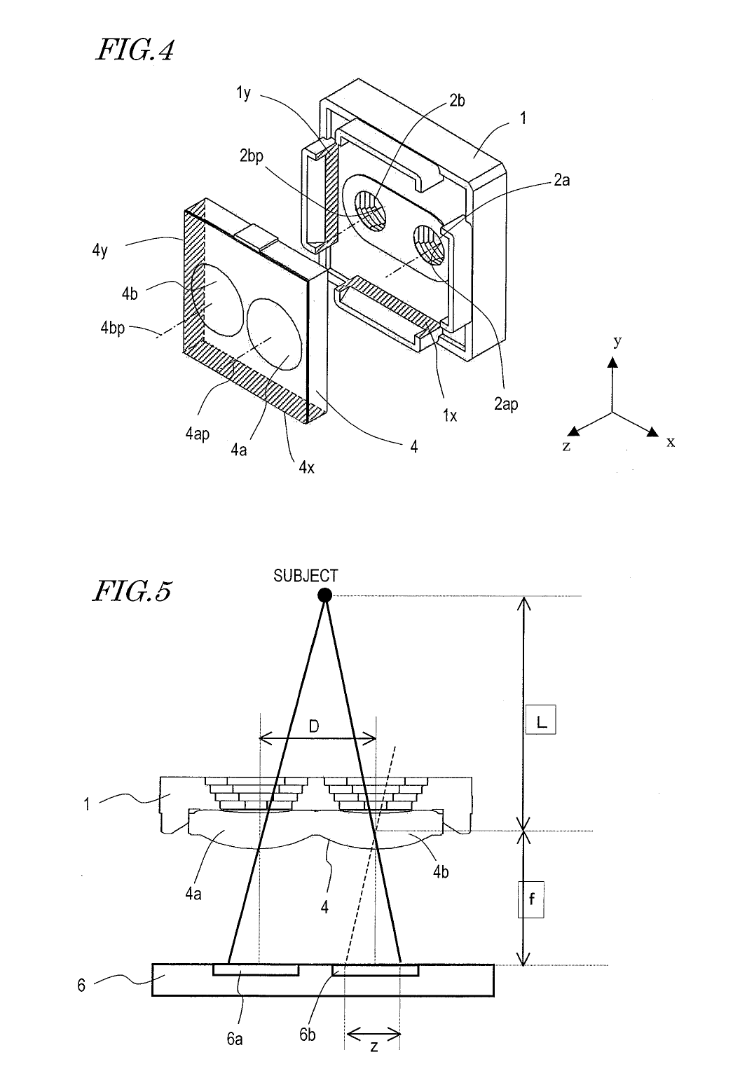

FIG. 2 is a cross-sectional view of the unit formed of the lens array 4 and the optical aperture section 1 taken along a plane parallel to a side surface thereof. FIG. 3 is a front view of the unit seen from the side of the optical aperture section 1, namely, from the side of the subject. FIG. 4 is an exploded isometric view of the unit seen from the side of the lens array 4.

As shown in these figures, the optical aperture section 1 further includes hoods 3a and 3b for preventing light from being obliquely incident on the lenses 4a and 4b. Since the optical apertures 2a and 2b and the hoods 3a and 3b of the optical aperture section 1 are integrally formed, the number of elements is decreased to reduce the cost. The optical aperture section 1 is also integrally formed by resin molding or the like. As described hereinafter in detail, the difference between the linear expansion coefficient of a material used to form the lens array 4 and the linear expansion coefficient of a material used to form the optical aperture section 1 has an absolute value of 0.7×10⁻⁵/° C. or less.

As shown in FIG. 1, the lens barrel 5 holds and fixes the unit formed of the optical aperture section 1 and the lens array 4 in the vicinity of an end thereof. The imaging section 6 is held and fixed in the vicinity of another end of the lens barrel 5. The imaging section 6 includes imaging areas 6a and 6b, each of which includes a great number of pixels arranged in two directions two-dimensionally. The imaging section 6 may include two imaging sensors such as CCDs or the like and the two imaging sensors may respectively include the imaging areas 6a and 6b. Alternatively, the imaging section 6 may include one imaging sensor, which may include the imaging areas 6a and 6b.

The imaging section 6 is located with respect to the lens array 4 such that two images of the subject formed by the lenses 4a and 4b are projected on the imaging areas 6a and 6b in a one-to-one relationship. The imaging section 6 is located on the opposite side to the optical aperture section 1 with respect to the lens array 4. A light shielding wall 8 is provided between the lens array 4 and the imaging section 6, between optical paths of the lenses 4a and 4b, in order to prevent each of the two images of the subject from being incident on the imaging area 6a or 6b not corresponding thereto.

Light from the subject passes the optical apertures 2a and 2b, is formed into images separately by the lenses 4a and 4b, and is projected on the imaging areas 6a and 6b. The imaging section 6 converts each of the images formed on the imaging areas 6a and 6b into an electric signal in accordance with the light intensity thereof. In order to transmit light of only a prescribed wavelength, an optical filter 7 may be provided between the lens array 4 and the imaging section 6. In order to prevent stray light from being incident on the imaging areas 6a and 6b, a light shielding film 9 may be provided in the vicinity of the optical filter 7.

The electric signals output from the imaging section 6 are subjected to image processing by means of various types of signal processing. For example, the parallax amount may be found using two images formed on the imaging areas 6a and 6b and to measure the distance to the subject. Such processing may be performed using a digital signal processor (not shown) or the like.

Now, with reference to FIG. 5, the principle of measuring the distance to a target using the images will be described.

An image on the imaging area 6a is defined as a basic reference. The image on the imaging area 6a is divided into a plurality of pixel blocks, each including 32×32 pixels. An area correlated to one pixel block of the imaging area 6a is searched for and specified in the image on the imaging area 6b, which is a reference image. This is the so-called “block matching” technique. Based on the parallax between the one pixel block and the specified pixel block, the distance to the subject is calculated.

The distance from each of the lenses 4a and 4b to the subject is defined as L[mm]. It is assumed that the lenses 4a and 4b have the same optical characteristics, and the focal distance thereof is f[mm]. The base line length, which is the distance between the lenses 4a and 4b (the distance between the optical axes), is defined as D[mm]. The parallax amount, which is the relative deviation between the pixel block in the basic image and the pixel block calculated by block matching is defined as z[pixels]. The pixel pitch of the imaging element is defined as p[mm/pixel]. The distance L to the subject can be found by the following expression 1.

$$L = D \times \frac{f}{z \times p} [ mm ] \qquad ( Expression 1 )$$

By using expression 1 as described above, the distance to the subject can be measured based on a pair of images taken.

According to the present invention, in order to maintain a high distance measuring accuracy even when the environmental temperature changes, the absolute value of the difference between the linear expansion coefficient of the material used to form the lens array 4 and the linear expansion coefficient of the material used to form the optical aperture section 1 is set to 0.7×10⁻⁵/° C. or less. Hereinafter, the reason for this will be described.

Regarding the compound eye camera module having the structure shown in FIG. 1, especially where the lens array 4 is formed of a resin, when the environmental temperature changes, the volume of the lens array 4 changes in accordance with the environmental temperature at a ratio defined by the linear expansion coefficient of the resin. As a result, the base line length D, which is the distance between the optical axes of the lenses 4a and 4b, expands or shrinks in accordance with the environmental temperature. This increases an error included in the result of the distance measurement. In addition, when the environmental temperature changes, the refractive index of the lens array 4 also changes, and so the focal distance f of the lenses changes. This also increases the error included in the result of the distance measurement.

The base line length D or the like changes due to the change of the environmental temperature. The true base line length D after expanding or shrinking by the change of the environmental temperature can be estimated by detecting the environmental temperature as long as the linear expansion coefficient of the resin used to form the lens array 4 is known. Thus, an accurate distance to the subject corrected in consideration of the influence by the change of the environmental temperature can be easily calculated.

For example, in the case where the compound eye camera module is mounted on a vehicle, the environmental temperature is rarely constant and changes moment by moment. In order to accurately measure the distance to the subject in such a situation, it is important to correct the distance in accordance with the change of the environmental temperature as described above in order to accurately measure the distance to the subject.

Against an error of the distance caused by the volume change of the lens array 4 or the like, the distance can be corrected by detecting the change of the environmental temperature as described above. However, in the compound eye camera module, the influence of the change of the environmental temperature is not exerted only on the lens array 4. As a result of a detailed investigation of the present inventors, it was found that the deviation between the centers 2ap and 2bp of the optical apertures 2a and 2b and the optical axes 4ap and 4bp of the lenses 4a and 4b, namely, the decentration, increases the error included in the measured distance.

However, the decentration is not easily correctable merely by detecting the environmental temperature, for the following reason. When the decentration occurs between each center 2ap, 2bp of the optical aperture 2a, 2b and the optical axis 4ap, 4bp of the corresponding lens 4a, 4b, the parallax amount changes in accordance with the image height of the subject, and this change is not linear to the image height. Therefore, it is very difficult to correct the parallax amount in accordance with the image height. In addition, when the decentration amount changes between each center 2ap, 2bp of the optical aperture 2a, 2b and the optical axis 4ap, 4bp of the corresponding lens 4a, 4b due the change of the environmental temperature, the parallax amount further changes. This makes it more difficult to correct the parallax amount in accordance with the environmental temperature or the image height.

Hereinafter, the result of investigation on how the deviation between the center of the optical aperture and the optical axis of the lens influences the image height and the parallax amount will be described.

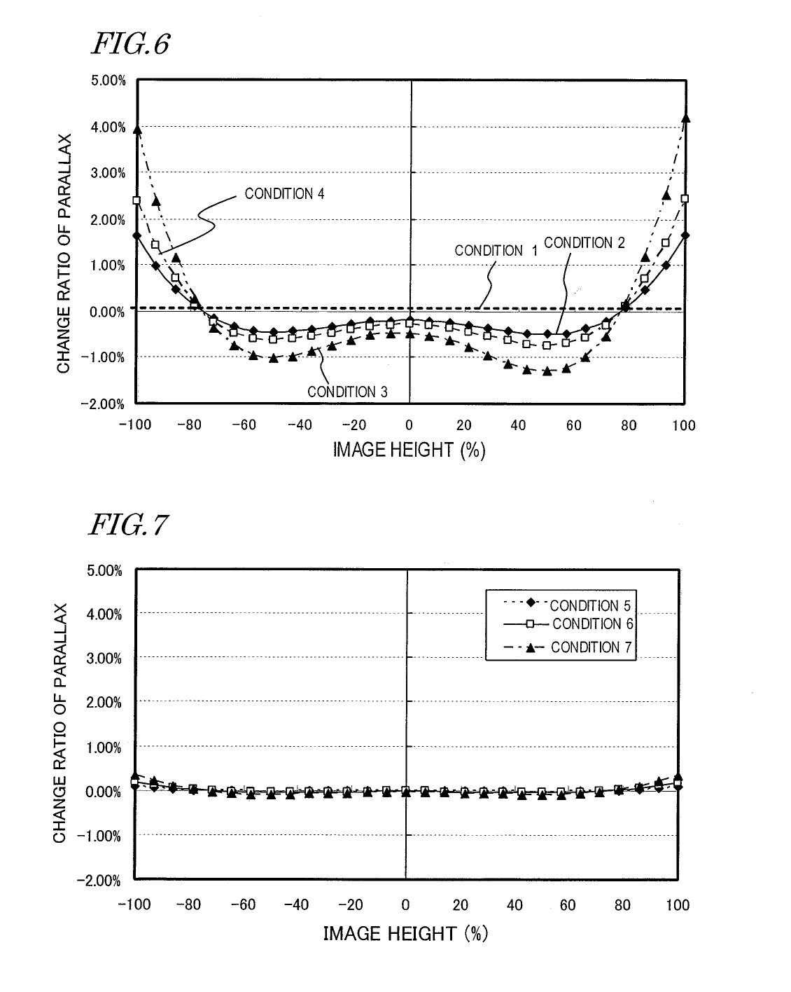

FIG. 6 shows the result of analysis on the change of the parallax amount with respect to the image height in the case where the decentration between the optical axis 4ap, 4bp of the lens 4a, 4b and the center 2ap, 2bp of the corresponding optical aperture 2a, 2b is varied in four stages. The analysis was performed by tracing the chief ray in the state where the base line length was 2.6 mm, the focal distance was 2.6 mm, and the subject was placed at a distance of 3000 mm from the lenses 4a and 4b. In FIG. 6, the horizontal axis represents the image height where the maximum image height is 100, and the vertical axis represents the change ratio of the parallax amount with respect to the normal parallax amount. Condition 1 represented by the dashed line shows the relationship between the image height and the change ratio of the parallax amount at the correct position with no decentration. Condition 2 represented by the solid line shows the relationship between the image height and the change ratio of the parallax amount in the case where the centers 2ap and 2bp of the optical apertures 2a and 2b are shifted by 5 μm in the base direction with respect to the optical axes of the lenses 4a and 4b. Condition 3 represented by the two-dot chain line shows the relationship between the image height and the change ratio of the parallax amount in the case where the centers 2ap and 2bp of the optical apertures 2a and 2b are shifted by 12.3 μm in the base direction with respect to the optical axes of the lenses 4a and 4b. Condition 4 represented by the one-dot chain line shows the relationship between the image height and the change ratio of the parallax amount in the case where the centers 2ap and 2bp of the optical apertures 2a and 2b are shifted by 7.3 μm in the base direction with respect to the optical axes of the lenses 4a and 4b.

As shown by the dashed line (condition 1) in FIG. 6, in the case where no decentration occurs between the optical axes 4ap and 4bp of the lenses 4a and 4b and the centers 2ap and 2bp of the optical apertures 2a and 2b, the change ratio of the parallax amount is zero regardless of the image height. This indicates that with no decentration, no error occurs in the measured distance regardless of the image height.

By contrast, in the case where, as shown by the solid line (condition 2) in FIG. 6, a decentration of 5 μm occurs, the change ratio of the parallax amount changes nonlinearly in accordance with the image height. Although not shown, the change ratio of the parallax amount due to decentration was analyzed in substantially the same manner by changing the distance to the subject under the same decentration condition. As a result, what was found is that it is very difficult to derive the relationship between the degree of change of the distance to the subject and the degree of change of the parallax amount with respect to each image height. Accordingly, it was found that it is very difficult to correct, by detecting the environmental temperature, the error in the measured distance caused by the decentration between the centers 2ap and 2bp of the optical apertures 2a and 2b and the optical axes 4ap and 4bp of the lenses 4a and 4b.

The decentration in condition 2 is assumed to be the decentration between the centers of the optical apertures and the optical axes of the lenses in an initial period of assembly. More specifically, the decentration in condition 2 is assumed to occur immediately after the compound eye camera module is assembled at room temperature, due to the deviation of the pitch between the optical apertures 2a and 2b of the optical aperture section 1 or the deviation of the pitch between the lenses 4a and 4b of the lens array 1.

Condition 3 (two-dot chain line) corresponds to a case where the linear expansion coefficient of the lens array 4 is different from the linear expansion coefficient of the optical aperture section 1, and the decentration amount increases by 7.3 μm in the base direction from the state of condition 2 by the change of the environmental temperature. Namely, this corresponds to a case where a decentration of 12.3 μm occurs from the state with zero decentration. The decentration of 7.3 μm corresponds to the decentration which occurs when the lens array 4 is formed of a cycloolefin polymer-based material having a linear expansion coefficient of 7.0×10⁻⁵/° C., the optical aperture section is formed of aluminum having a linear expansion coefficient of 2.3×10⁻⁵/° C., and the temperature changes by 60° C. As is clear from FIG. 6, when the environment temperature changes and the decentration amount is larger, the change ratio of the parallax amount is lager. As a result, the error in the measured distance is increased.

Condition 4 (one-dot chain line) corresponds to a case where the linear expansion coefficient of the lens array 4 is different from the linear expansion coefficient of the optical aperture section 1, and the decentration amount increases by 7.3 μm in the base direction from the state of condition 1 by the change of the environmental temperature.

As shown by the two-dot chain line in FIG. 6, the change ratio of the parallax amount with respect to the image height is nonlinear. It is understood that even if the decentration amount between the centers of the optical apertures and the optical axes of the lenses is calculated based on the environmental temperature, it is very difficult to correct the measured distance because the change ratio of the parallax amount significantly varies depending on the image height. In other words, even though the environmental temperature changes linearly, it is very difficult to find the relationship between environmental temperature and the change ratio of the parallax amount with respect to the image height before and after the change of the environmental temperature.

As shown by the one-dot chain line in FIG. 6, when the decentration amount is small, the change ratio of the parallax amount is also small. However, the change ratio is not constant with respect to the image height. Therefore, as in the case of condition 3, it is very difficult to find the relationship between environmental temperature and the change ratio of the parallax amount with respect to the image height before and after the change of the environmental temperature. Thus, it was found substantially impossible to accurately correct the change of the decentration amount in accordance with the environmental temperature using the linear expansion coefficient of the lens array 4 including the lenses and the linear expansion coefficient of the optical aperture section 1 including the optical apertures, the linear expansion coefficients being a cause of the decentration.

For the compound eye camera module in this embodiment, the linear expansion coefficient of the material of the optical aperture section 1 is generally the same as the linear expansion coefficient of the material of the lens array 4, in order not to increase the decentration amount between the centers of the optical apertures and the optical axes of the lenses even when the environmental temperature changes. Namely, in order to maintain a necessary accuracy of the measured distance, the compound eye camera module is structured such that the decentration amount between the optical axes of the lenses and the centers of the optical apertures is within a certain range even when the environmental temperature changes, instead of being structured to estimate the decentration amount with respect to the change of the environmental temperature and correct the measured distance.

Regarding the specific materials of the lens array 4 and the optical aperture section 1, for example, where a cycloolefin-based resin is used for the lens array, the linear expansion coefficient thereof is 7×10⁻⁵/° C., and where polycarbonate is used for the optical aperture section 1, the linear expansion coefficient thereof is 6.8×10⁻⁵/° C. The linear expansion coefficients of these two materials are substantially the same. Any other appropriate combination of materials than this is selectable. For example, the linear expansion coefficients can be adjusted by dispersing glass in ABS resin.

FIG. 7 shows the result of analysis on the change of the parallax amount with respect to the image height in the case where the decentration, i.e., the deviation, between the optical axis 4ap, 4bp of the lens 4a, 4b and the center 2ap, 2bp of the corresponding optical aperture 2a, 2b is varied in three stages. The analysis was performed by tracing the chief ray in the state where the base line length was 2.6 mm, and the subject was placed at a distance of 3000 mm from the lenses 4a and 4b. In FIG. 7, the horizontal axis represents the image height where the maximum image height is 100, and the vertical axis represents the change ratio of the parallax amount with respect to the correct parallax amount. The dashed line shows the relationship in the case where the linear expansion coefficient of the lens array 4 is 7.0×10⁻⁵/° C., the linear expansion coefficient of the optical aperture section 1 is 6.8×10⁻⁵/° C., and the temperature changes by 60° C. (condition 5). The solid line shows the relationship in the case where the linear expansion coefficient of the lens array 4 is 7.0×10⁻⁵/° C., the linear expansion coefficient of the optical aperture section 1 is 6.65×10⁻⁵/° C., and the temperature changes by 60° C. (condition 6). The two-dot chain line shows the relationship in the case where the linear expansion coefficient of the lens array 4 is 7.0×10⁻⁵/° C., the linear expansion coefficient of the optical aperture section 1 is 6.3×10⁻⁵/° C., and the temperature changes by 60° C. (condition 7). The difference between the linear expansion coefficients in conditions 5, 6 and 7 is respectively, 0.2×10⁻⁵/° C., 0.35×10⁻⁵/° C., and 0.7×10⁻⁵/° C.

As is clear from comparing FIG. 7 and FIG. 6, the change of the decentration amount between the optical axes of the lenses and the centers of the optical apertures is suppressed by keeping the absolute value of the difference in the linear expansion coefficient between the lens array 4 and the optical aperture section 1 to a prescribed value or less. It is understood that as a result, the change of the parallax amount is significantly suppressed. It is also understood that the change of the parallax amount does not depend on the image height almost at all.

As understood from FIG. 7, in order to reduce the measuring accuracy value to 0.3% or less, namely, in order to reduce the change ratio of the parallax to 0.3% or less, the absolute value of the difference in the linear expansion coefficient between the lens array 4 and the optical aperture section 1 needs to be 0.7×10⁻⁵/° C. or less. In order to reduce the measuring accuracy value (change ratio of the parallax) to 0.2% or less, the absolute value of the difference in the linear expansion coefficient between the lens array 4 and the optical aperture section 1 needs to be 0.35×10⁻⁵/° C. or less. In order to reduce the measuring accuracy value (change ratio of the parallax) to 0.1% or less, the absolute value of the difference in the linear expansion coefficient between the lens array 4 and the optical aperture section 1 needs to be 0.2×10⁻⁵/° C. or less. Accordingly, the absolute value of the difference in the linear expansion coefficient between the lens array 4 and the optical aperture section 1 is preferably 0.7×10⁻⁵/° C. or less, and more preferably 0.35×10⁻⁵/° C. or less. Where the absolute value of the difference in the linear expansion coefficient between the lens array 4 and the optical aperture section 1 is 0.2×10⁻⁵/° C. or less, the influence of the change of the decentration amount between the optical axes of the lenses and the centers of the optical apertures due to the change of the environmental temperature can be almost totally eliminated.

With the compound eye camera module in this embodiment, as described above, the difference in the linear expansion coefficient between the material of the lens array and the material of the optical aperture section is set to 0.7×10⁻⁵/° C. or less. Owing to this, the decentration amount between the optical axes of the lenses and the centers of the optical apertures is suppressed from changing in accordance with the environmental temperature, although such a change is difficult to be corrected merely by considering the expansion amount or shrinkage amount of the materials used to form the compound eye camera module in accordance with the environmental temperature. Since the decentration amount is suppressed from changing, the change of the parallax amount can also be suppressed. Accordingly, the distance measurement accuracy can be remarkably improved.

As understood from the graph of FIG. 6, unless the decentration amount between the optical axes of the lenses and the centers of the optical apertures is exactly zero, the change ratio of the parallax amount varies depending on the image height. However, as described above, by setting the absolute value of the difference in the linear expansion coefficient between the lens array 4 and the optical aperture section 1 to a prescribed value or less, the change of the decentration amount caused by the change of the environmental temperature is suppressed. Therefore, the change ratio of the parallax amount does not change by the change of the environmental temperature. Accordingly, even if the decentration amount between the optical axes of the lenses and the centers of the optical apertures when the compound eye camera module is assembled is not exactly zero, the change of the change ratio of the parallax amount caused by the change of the environmental temperature is suppressed. Thus, the accuracy of distance measurement can be remarkably improved.

By setting the absolute value of the difference in the linear expansion coefficient between the lens array 4 and the optical aperture section 1 to a prescribed value or less, the influence of the measuring error caused by the decentration, i.e., the deviation, between the optical axis 4ap, 4bp of the lens 4a, 4b and the center 2ap, 2bp of the corresponding optical aperture 2a, 2b can be minimum regardless of the environmental temperature. However, this cannot suppress the change of the base line length D caused by the change of the environmental temperature. Accordingly, it is preferable to find the change amount of the base line length D caused by the change of the environmental temperature using the linear expansion coefficient of the material used to form the lens array 4 and to correct the parallax amount based on the change amount of the base line length D as described above. This makes it possible to perform highly accurate measurement regardless of the environmental temperature.

Owing to the above-described structure, the change of the decentration amount caused by the change of the environmental temperature can be suppressed. However, in order to decrease the initial value itself of the decentration amount, it is important to reduce the decentration amount at the time of assembly to a minimum possible value in addition to making the linear expansion coefficients of the lens array 4 and the optical aperture section 1 substantially the same with each other. Therefore, for the compound eye camera module in this embodiment, the optical aperture section 1 and the lens array 4 are positioned with respect to each other in a state of contacting each other, such that that centers of the optical apertures of the optical aperture sections 1 and the optical axes of the lenses match each other, and then bound together. Hereinafter, a method for producing the compound eye camera module will be described including this point.

As shown in FIG. 4, regarding the unit formed of the optical aperture section 1 and the lens array 4, an x axis and a y axis are defined in directions parallel to a plane on which the lenses 4a and 4b of the lens array 4 are located, and a z axis is defined in a thickness direction of the lens array 4. The optical aperture section 1 has a reference plane 1x and a reference plane 1y which are parallel to the optical axes of the lenses 4a and 4b and also respectively parallel to the x axis and y axis. The lens array 4 has a reference plane 4x and a reference plane 4y which are parallel to the optical axes of the lenses 4a and 4b and also respectively parallel to the x axis and y axis.

For producing the compound eye camera module, the optical aperture section 1, the lens array 4, the lens barrel 5 and the imaging section 6 each processed to have a prescribed shape are first prepared. Next, the optical aperture section 1 and the lens array 4 are bound together to form a unit. At this point, as shown in FIG. 4, the reference plane 1x of the optical aperture section 1 and the reference plane 4x of the lens array 4 are put into contact with each other such that the centers 2ap and 2bp of the optical apertures 2a and 2b respectively match the optical axes 4ap and 4bp of the lenses 4a and 4b. Also, the reference 1y of the optical aperture section 1 and the reference plane 4y of the lens array 4 are put into contact with each other. Thus, the lens array 4 is positioned with respect to the optical aperture section 1.

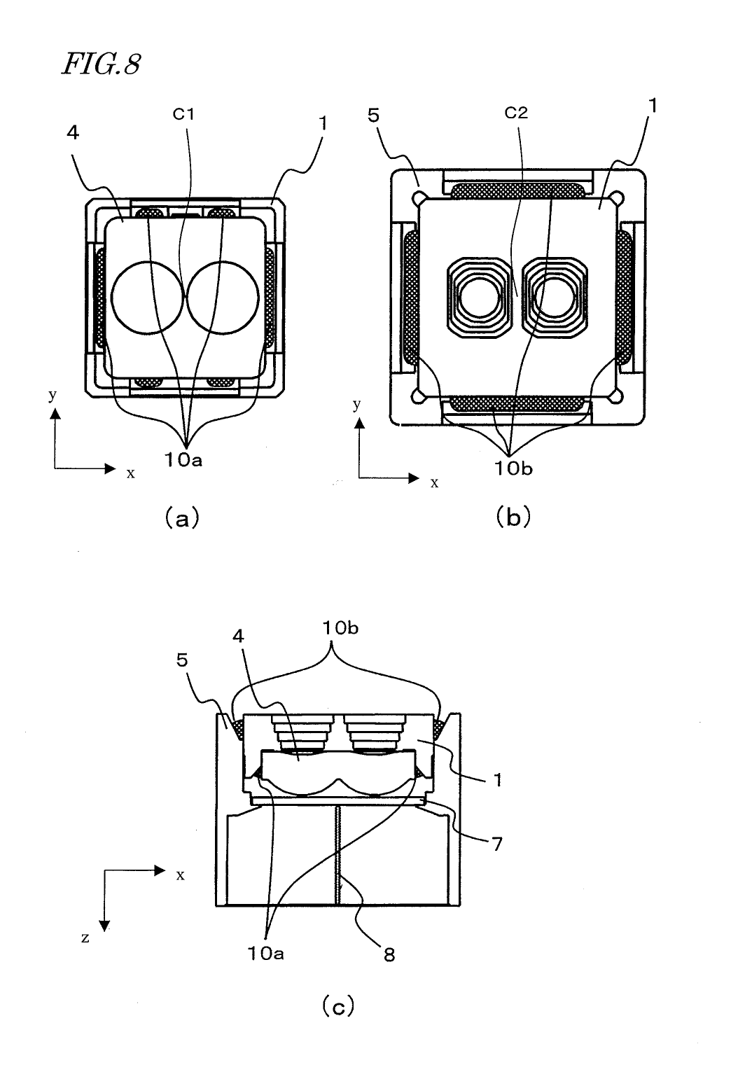

Then, as shown in FIG. 8(a) and FIG. 8(c), in the state where the lens array 4 is positioned with respect to the optical aperture section 1, an adhesive (first adhesive) 10a is located between the lens array 4 and the optical aperture section 1. At this point, the position, area and amount of the adhesive 10a are set such that the adhesive 10a is symmetrical with respect to center C1 of the plane on which the lenses 4a and 4b of the lens array 4 are located or center C1 of a plane vertical to the optical axes of the lenses 4a and 4b. In this embodiment, the position, area and amount of the adhesive 10a in the y direction is symmetrical with respect to the center C1 in an up-down direction. The position, area and amount of the adhesive 10a in the x direction is symmetrical with respect to the center C1 in a left-right direction. Then, until the adhesive 10a is cured, the state where the lens array 4 is positioned with respect to the optical aperture section 1 is maintained. Thus, the lens array 4 and the optical aperture section 1 are bound together and the unit is formed. In addition, the decentration amount can be suppressed within a processing tolerance of each component.

Next, the unit is bound with the lens barrel 5. As shown in FIG. 8(b) and FIG. 8(c), the unit is inserted into the lens barrel 5, and the optical aperture section 1 and a plane of the lens barrel 5 which is parallel to the lenses 4a and 4b are positioned with respect to each other in a state of contacting each other. Then, an adhesive (second adhesive) 10b is located between the lens barrel 5 and the optical aperture section 1 of the unit. At this point, the position, area and amount of the adhesive 10b are set such that the adhesive 10b is symmetrical with respect to center C2 of the plane on which the lenses 4a and 4b of the lens array 4 of the unit are located (plane vertical to the optical axes of the lenses 4a and 4b). In this embodiment, the position, area and amount of the adhesive 10b in the y direction is symmetrical with respect to the center C2 in the up-down direction. The position, area and amount of the adhesive 10b in the x direction is symmetrical with respect to the center C2 in the left-right direction. Then, until the adhesive 10b is cured, the state where the unit is positioned with respect to the lens barrel 5 is maintained. Thus, the optical aperture section 1 and the lens barrel 5 are bound together, and so the optical aperture section 1, the lens array 4 and the lens barrel 5 are integrally bound together.

By setting the application area and amount of the adhesive symmetrical with respect to the center C1 or C2 as described above, the stress caused by the expansion or shrinkage of the adhesive due to the change of the environmental temperature is applied on the lens array 4, the optical aperture section 1 and the lens barrel 5 symmetrically in the up-down direction and the left-right direction. Accordingly, the assembly of the lens array 4, the optical aperture section 1 and the lens barrel 5 is expanded or shrunk with respect to the center of the elements. Owing to this, the positional change of the optical axis of each optical system can be estimated highly accurately, and so highly accurate compensation for the temperature change is realized.

In this embodiment, the optical aperture section 1 includes the optical apertures 2a and 2b integrally. In the case where the optical apertures 2a and 2b are formed in the optical aperture section 1 highly accurately, such an integral structure is advantageous in that only one element needs to be positionally aligned to the lens array 4 and the assembly is simplified. However, in the case where the centers of the optical apertures 2a and 2b are not distanced from each other at a prescribed accuracy, or in the case where the optical apertures 2a and 2b are formed in the optical aperture section 1 highly accurately but the positional accuracy of the lenses 4a and 4b in the lens array 4 is not high, the optical aperture section 1 may have a structure in which the positions of the optical apertures 2a and 2b are independently adjustable such that the optical axes of the lenses 4a and 4b respectively match the centers of the optical apertures 2a and 2b.

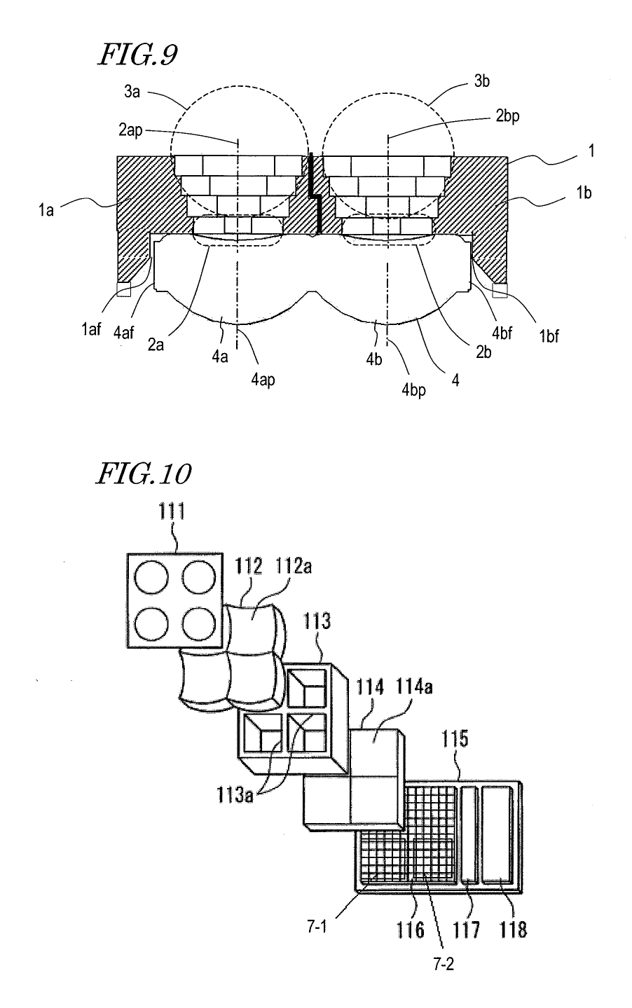

FIG. 9 shows a cross-sectional view of a unit formed of the optical aperture section 1 and the lens array 4 having such a structure. As shown in FIG. 9, the optical aperture section 1 includes a first optical aperture section 1a including an optical aperture 2a and a second optical aperture section 1b including an optical aperture 2b. By dividing the optical aperture section 1 into two and making the divided optical aperture sections movable independently, the optical aperture section 1a may be translated or rotated to be positioned with respect to the lens 4a of the lens array 4, such that the optical axis 4ap of the lens 4a matches the center 2ap of the optical aperture 2a. Preferably, in the state where the optical axis 4ap of the lens 4a matches the center 2ap of the optical aperture 2a, a plane 4af of the lens array 4 which is parallel to the optical axis of the lens 4a and a plane 1af of the first optical aperture section 1a which is parallel to the optical axis of the lens 4a are positioned with respect to each other in a state of contacting each other.

Similarly, the optical aperture section 1b may be translated or rotated to be positioned with respect to the lens 4b of the lens array 4, such that the optical axis 4bp of the lens 4b matches the center 2bp of the optical aperture 2b. Preferably, in the state where the optical axis 4bp of the lens 4b matches the center 2bp of the optical aperture 2b, a plane 4bf of the lens array 4 which is parallel to the optical axis of the lens 4b and a plane 1bf of the second optical aperture section 1b which is parallel to the optical axis of the lens 4a are positioned with respect to each other in a state of contacting each other.

The lens array 4, and the first optical aperture sections 1a and the second optical aperture section 1b may be bound together by an adhesive in a state of being positioned in this manner. Owing to this, adjustments can be made in order to reduce the decentration amount of the center of each optical aperture with respect to the optical axis of the corresponding lens. As a result, even in a lens array including a plurality of lenses integrally formed, the decentration between the optical axis of each lens and the center of the corresponding optical aperture can be made infinitely close to zero, and thus accurate distance measurement can be guaranteed.

In this embodiment, the lens array 4 includes two lenses 4a and 4b. Substantially the same effect is provided where the lens array 4 includes three or more lenses.

In this embodiment, the optical filter 7 is located in the vicinity of the lens array 4. Alternatively, the optical filter 7 may be located for each pixel on the imaging section 6.

Needless to say, the resin material for used to form the optical aperture section 1 needs to be light shielding. The light shielding property may be obtained by adding 3% or more of carbon to the resin material used to form the optical aperture section 1.

### INDUSTRIAL APPLICABILITY

A compound eye camera module according to the present invention is useful for a vehicle-mountable distance measuring device or for an imaging device of three-dimensional images.

1. A compound eye camera module, comprising:
a lens array including a plurality of lenses located on a same plane;
an imaging section including a plurality of imaging areas on which a plurality of images of a subject respectively formed by the plurality of lenses are projected in a one-to-one relationship, the imaging section converting each of the plurality of projected images into an electric signal; and
an optical aperture section including a plurality of optical apertures corresponding to the plurality of lenses in a one-to-one relationship, with the optical aperture section and the imaging section being located on opposite sides of the lens array;
wherein a difference between a linear expansion coefficient of a material which forms the lens array and a linear expansion coefficient of a material which forms the optical aperture section has an absolute value of 0.7×10⁻⁵/° C. or less.

2. The compound eye camera module of claim 1, wherein the difference between the linear expansion coefficient of the material which forms the lens array and the linear expansion coefficient of the material which forms the optical aperture section has an absolute value of 0.35×10⁻⁵/° C. or less.

3. The compound eye camera module of claim 1, wherein the difference between the linear expansion coefficient of the material which forms the lens array and the linear expansion coefficient of the material which forms the optical aperture section has an absolute value of 0.2×10⁻⁵/° C. or less.

4. The compound eye camera module of claim 1, wherein the optical aperture section includes a hood for preventing light from being obliquely incident on the plurality of lenses.

5. The compound eye camera module of claim 1, wherein the optical aperture section and the lens array are positioned in a state of contacting each other, the center of each of the optical apertures of the optical aperture section respectively matching an optical axis of the corresponding lens of the lens array.

6. The compound eye camera module of claim 1, wherein the optical aperture section has a structure with which positions of the plurality of optical apertures are independently adjustable.

7. The compound eye camera module of claim 1, further comprising a lens barrel for supporting the optical aperture section and the imaging section; wherein:
the lens array and the optical aperture section are fixed to each other by a first adhesive located symmetrically with respect to the center of the lens array in a plane vertical to the optical axes of the plurality of lenses; and
the lens barrel and the optical aperture section are fixed to each other by a second adhesive located symmetrically with respect to the center of the lens array in the plane vertical to the optical axes of the plurality of lenses.

8. A method for producing a compound eye camera module including a lens array including a plurality of lenses located on a same plane; an imaging section including a plurality of imaging areas on which a plurality of images of a subject respectively formed by the plurality of lenses are projected in a one-to-one relationship, the imaging section converting each of the plurality of projected images into an electric signal; and an optical aperture section including a plurality of optical apertures corresponding to the plurality of lenses in a one-to-one relationship, with the optical aperture section and the imaging section being located on opposite sides of the lens array; wherein a difference between a linear expansion coefficient of a material which forms the lens array and a linear expansion coefficient of a material which forms the optical aperture section has an absolute value of 0.7×10⁻⁵/° C. or less, the method comprising:
binding together the optical aperture section and the lens array by a first adhesive in a state where a plane of the optical aperture section which is parallel to the optical axes of the plurality of lenses is in contact with a plane of the lens array which is parallel to the optical axes of the plurality of lenses such that the center of each optical aperture of the optical aperture section is located on the optical axis of the corresponding lens.

9. The method for producing the compound eye camera module of claim 8, wherein the lens array and the optical aperture section are fixed to each other by locating the first adhesive symmetrically with respect to the center of the lens array in a plane vertical to the optical axes of the plurality of lenses.
